(19) United States
(12) Patent Application Publication
(10) Pub. No.: US 2014/0211264 A1
(43) Pub. Date: Jul. 31, 2014

(54) TECHNIQUES PERTAINING TO DOCUMENT PRINTING

(71) Applicant: HEWLETT-PACKARD COMPANY, Fort Collins, CO (US)

(72) Inventors: Sekhar Muni Sirigiri, Bangalore (IN); Prabhakaran Shinoj, Bangalore (IN); Robert Alan Ulichney, Andover, MA (US); Matthew D. Gaubatz, Bellevue, WA (US)

(73) Assignee: HEWLETT-PACKARD COMPANY, Fort Collins, CO (US)

(21) Appl. No.: 13/750,044

(22) Filed: Jan. 25, 2013

(51) Int. Cl. G06F 3/12

(52) U.S. Cl. CPC G06F 3/1237
USPC 358/3.06; 358/1.15

(57) ABSTRACT

Techniques pertaining to printing a document are disclosed. A computer server may receive decoded document metadata and locate a document in a document repository using the document metadata. The server may determine whether the document metadata is indicative of a most recent version of the document and, if not, retrieve the most recent version of the document. The server may also create a tag for the retrieved most recent version of the document comprised of up to date document metadata in which the tag data is embedded in a graphic that is merged with the most recent version of the document. The server may create a print job for the most recent version of the document and send the print job to a network enabled printer over a network connection.

### BACKGROUND

Document management applications are widely used in enterprises. Often, the document management application may be remotely accessed by multiple devices having different form factors. Such devices may include personal computers, tablet computers and smartphones or personal digital assistant (PDA) devices. It can be challenging to access and print documents from devices having smaller form factors like the tablet computer, smartphone, or PDA from cloud based document management services.

### BRIEF DESCRIPTION OF THE DRAWINGS

FIG. 1A illustrates an embodiment of a system architecture for printing documents.

FIG. 1B illustrates another embodiment of a system architecture for printing documents.

FIG. 2 illustrates an embodiment of scanner.

FIG. 3 illustrates an embodiment of a tablet computer and a smartphone/PDA.

FIG. 4 illustrates an embodiment of a logic flow.

FIG. 5 illustrates an embodiment of a logic flow.

### DETAILED DESCRIPTION

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Often, a user would like to print the most recent version of a document from a document management application for an enterprise. In some cases, the user may not know certain document metadata such as the document identifier and document location but may have a paper copy of the document. The paper copy of the document may or may not be the most recent version of the document and the user may wish to obtain an updated printed copy of the most recent version of the document from the enterprise's document management application. This objective may be achieved if the existing document is tagged with metadata that can be scanned or imaged and subsequently interpreted by (or on behalf of) the document management application.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

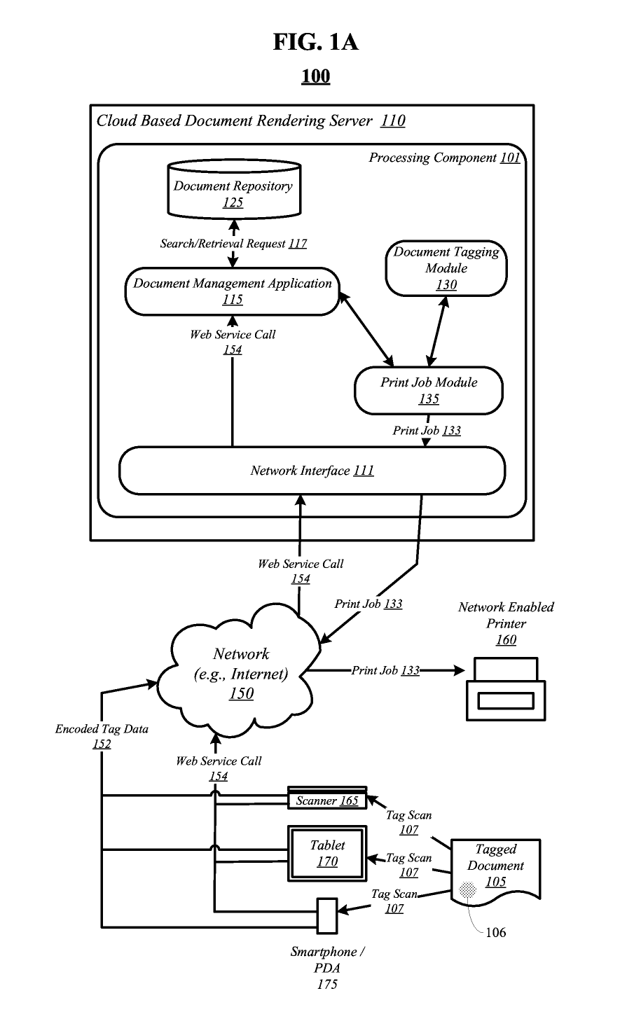

FIG. 1A illustrates an embodiment of a system architecture 100 for printing documents. This embodiment described herein facilitates the identification and printing of an updated version of a document from a document management application using a printed copy of the document that may or may not be the most recent version. The existing printed copy of the document may include a graphic 106 somewhere within the document. The graphic 106 may be relatively inconspicuous such as a logo, a watermark, or some other visual indicator.

The graphic 106 may be more naturally integrated into the document than say, for instance, a bar code. The graphic 106 may be tagged with document metadata. The metadata may include, for example, a document identifier a document location, and a document version, among other types of metadata. The document identifier may be indicative of a name or title of the document or a numeric identifier given the document by the document management application 115. The document location may be indicative of a location for the document, such as a universal resource locator (URL), a drive/directory identifier, a network address, or some other suitable location information indicative of the location of the document within the file management system. The document version data may be indicative of the specific version of the document that was printed. One common function of document management applications may be to save newer versions of the same document. Thus, multiple versions detailing the evolution of a document may be stored in the document management system.

A tagged document 105 may be the current printed version of a document in the user's possession. The user may wish to print the most recent version of the document, however. This task may be difficult if the user does not know the document metadata offhand in order to directly access the document management system. The tagged document 105 includes the document metadata embedded in a non-human readable format. Moreover, the document metadata may be inconspicuously integrated into a graphic 106 somewhere within the tagged document 105. The graphic 106 is likely designed to be a natural part of the tagged document 105 such as a logo or watermark or the like. The graphic 106 need not be present on every page of a multi-page document. If the graphic is present on multiple pages, then any page containing the graphic may be scanned to retrieve and automatically print the latest version of the document.

The user may be in possession of or near a network enabled imaging device capable of imaging or scanning the tagged document 105, more specifically, the graphic 106 containing the embedded metadata. Such an imaging device may include, but is not limited to, a scanner 165, a camera equipped tablet computer 170, a camera equipped smartphone or PDA 175. Using one of the aforementioned devices, the user may scan the graphic 106 (e.g., tag scan 107) or take a picture of the graphic 106 (e.g., tag scan 107) using the internal camera. In this embodiment, the scanner 165, tablet computer 170, or smartphone/PDA 175 may decode the image of the graphic 106 to recover the document metadata. The recovered document metadata may be uploaded to the server 110 in a web service call 154.

The server 110 may include components such as a processing component 101, a document management application 115, a document repository 125, a document tagging module 130, a print job module 135, and a network interface 111.

The document management application 115 may receive a web service call 154 that includes recovered document metadata. The recovered document metadata is presented to the document management application 115. The document management application 115 may then interpret the document metadata to search for and locate the document within a document repository 125. In the process of searching, the document management application 115 may further determine if the document version identifier in the document metadata corresponds to the most recent version of the document. If not, the most recent version of the document is returned to the document management application 115. This retrieved document along with the document metadata may then be forwarded to a print job module 135. Before creating and forwarding the actual print job 133, the metadata is forwarded to a document tagging module 130. The document tagging module 130 may then create a tag to be merged with or incorporated into the document to be printed to create the print job 133.

The process of creating a metadata tag comprised document metadata may utilize, for example, a technique known as clustered dot half-toning as is commonly used in both dry toner and liquid toner electro-photographic processes. More specifically, the tagging method may take as input any grayscale image (e.g., logo) and a payload of data (e.g., document metadata) to be encoded and produce a bi-tonal clustered dot halftone of that image in which selected halftone clusters are shifted to carry varying numbers of bits from the payload data. The resulting data bearing halftone is referred to as a “graphical tag”. The graphical tag image may then be merged with the document to be printed to create the print job 133. In addition, because of the small size and large number of clustered dot cells in printed halftones, the bit density is quite high (over 2,000 per square inch.

The print job module 135 may then create a print job 133 comprised of the document and the graphical document metadata tag to be sent to a remote network enabled printer 160 where it can be executed. The result is a printed copy of the most recent version of the original tagged document 105.

FIG. 1B illustrates another embodiment of a system architecture 100 for printing documents. This embodiment described herein also facilitates the identification and printing of an updated version of a document from a document management application using a printed copy of the document that may or may not be the most recent version. The existing printed copy of the document may include a graphic 106 somewhere within the document. The graphic 106 may be relatively inconspicuous such as a logo, a watermark, or some other visual indicator.

The graphic 106 may be more naturally integrated into the document than say, for instance, a bar code. The graphic 106 may be tagged with document metadata. The metadata may include, for example, a document identifier a document location, and a document version, among other types of metadata. The document identifier may be indicative of a name or title of the document or a numeric identifier given the document by the document management application 115. The document location may be indicative of a location for the document, such as a universal resource locator (URL), a drive/directory identifier, a network address, or some other suitable location information indicative of the location of the document within the file management system. The document version data may be indicative of the specific version of the document that was printed. One common function of document management applications may be to save newer versions of the same document. Thus, multiple versions detailing the evolution of a document may be stored in the document management system.

A tagged document 105 may be the current printed version of a document in the user's possession. The user may wish to print the most recent version of the document, however. This task may be difficult if the user does not know the document metadata offhand in order to directly access the document management system. The tagged document 105 includes the document metadata embedded in a non-human readable format. Moreover, the document metadata may be inconspicuously integrated into a graphic 106 somewhere within the tagged document 105. The graphic 106 is likely designed to be a natural part of the tagged document 105 such as a logo or watermark or the like. The graphic 106 need not be present on every page of a multi-page document. If the graphic is present on multiple pages, then any page containing the graphic may be scanned to retrieve and automatically print the latest version of the document.

The user may be in possession of or near a network enabled imaging device capable of imaging or scanning the tagged document 105, more specifically, the graphic 106 containing the embedded metadata. Such an imaging device may include, but is not limited to, a scanner 165, a camera equipped tablet computer 170, a camera equipped smartphone or PDA 175. Using one of the aforementioned devices, the user may scan the graphic 106 (e.g., tag scan 107) or take a picture of the graphic 106 (e.g., tag scan 107) using the internal camera. The scanner 165 may scan the graphic 106 and upload the scanned image (e.g., encoded tag data 152) to a cloud based document rendering server (the “server”) 110 over a network 150 such as the Internet. Similarly, the tablet computer 170 or the smartphone/PDA 175 may take a picture of the graphic 106 and upload the image (e.g., encoded tag data 152) to the server 110. In this embodiment, the scanned or photo image of the graphic has not been decoded prior to uploading to the server 110.

The server 110 may include components such as a processing component 101, data tag decoder 120, a document management application 115, a document repository 125, a document tagging module 130, a print job module 135, and a network interface 111. The data tag decoder 120 may receive the uploaded encoded tag data 152 from any of the scanner 165, the tablet computer 170, smartphone/PDA 175 or other suitable network enabled imaging device. The data tag decoder 120 may analyze the image of the graphic 106 to decode the data embedded into the graphic 106. Once decoded, the decoded tag data 122 indicative of the document metadata may be forwarded to the document management application 115.

The document management application 115 may receive decoded tag data 122 that includes the recovered document metadata. The recovered document metadata is presented to the document management application 115. The document management application 115 may then interpret the document metadata to search for and locate the document within a document repository 125. In the process of searching, the document management application 115 may further determine if the document version identifier in the document metadata corresponds to the most recent version of the document. If not, the most recent version of the document is returned to the document management application 115. This retrieved document along with the document metadata may then be forwarded to a print job module 135. Before creating and forwarding the actual print job 133, the metadata is forwarded to a document tagging module 130. The document tagging module 130 may then create a tag to be merged with or incorporated into the document to be printed to create the print job 133.

The print job module 135 may then create a print job 133 comprised of the document and the graphical document metadata tag to be sent to a remote network enabled printer 160 where it can be executed. The result is a printed copy of the most recent version of the original tagged document 105.

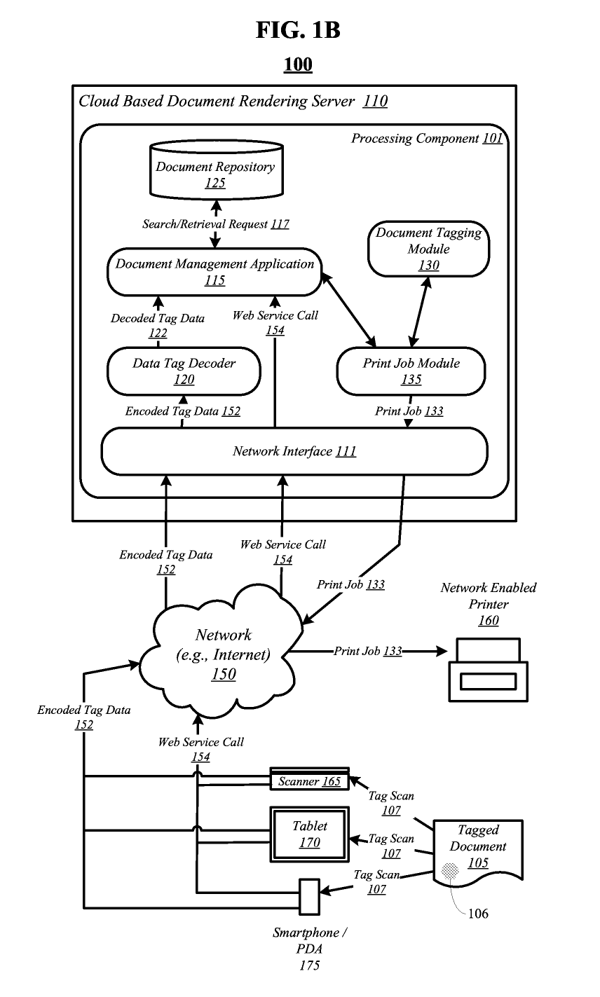

FIG. 2 illustrates an embodiment of a scanner 165. The scanner 165 includes a processing component 205, an imaging device 210, a communications interface 215, and an image processing application 220. Some embodiments may also include a tag decoder application 225.

The processing component 205 may be operative to control the other components in the scanner 165. The imaging device 210 may be operative to scan an image of a paper document that has been placed in a viewing area of the imaging device 210. Specifically, a user may place a part of the document that contains the graphic 106 with the encoded tag data 152 within the field of view of the imaging device 210. The imaging device 210 may then capture an image of the graphic 106. The captured image may be forwarded to the image processing application 220 for processing. The processing may include formatting the image data for transport across a network 150 to server 110 via the communications interface 215. The formatted image may then be transported across the network 150 to the server 110.

In some cases the scanner 165 may be coupled with a computer that is coupled with the network 150 such that the formatted image data is sent to the server 110 through the computer. Moreover, the scanner may be coupled to the network or a computer over a wired or wireless connection. Typical wireless connections may include the Bluetooth protocol or any of the 802.11 family of protocols used ubiquitously for local area network (LAN) connections.

In embodiments that include a tag decoder application 225, the captured image data may be subject to the same processing as described above with respect to the data tag decoder 120 of FIG. 1. Thus, the image processing application 220 decodes the image to recover the document metadata for the scanned graphic 106. The image processing application 220 may then create a web service call to the server 110 in which the web service call includes the document metadata. The web service call may then be forwarded to the server 110 over network 150 by means described above.

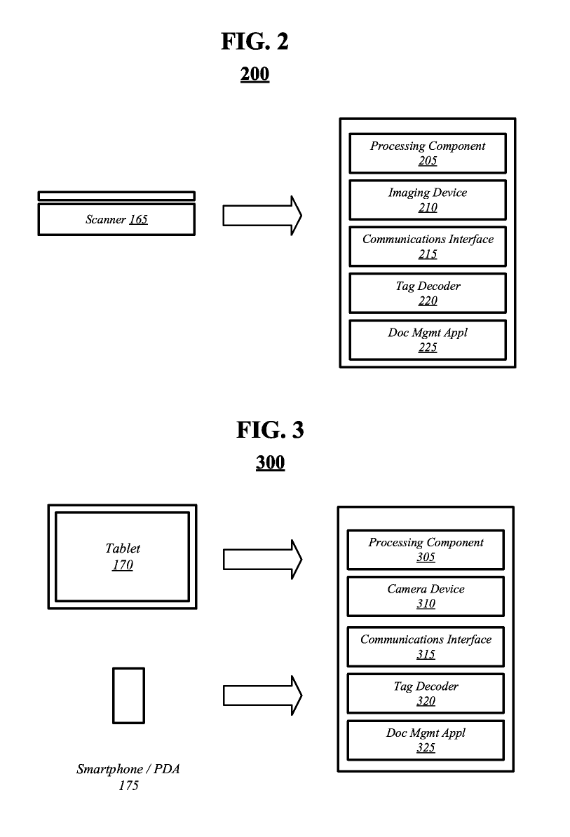

FIG. 3 illustrates an embodiment of a tablet computer 170 and a smartphone/PDA 175. The tablet computer 170 and smartphone/PDA 175 may each include a processing component 305, a camera device 310, a communications interface 315, and an image processing application 320. Some embodiments may also include a tag decoder application 325.

The processing component 305 may be operative to control the other components in the tablet computer 170 and smartphone/PDA 175. The camera device 310 may be operative to photograph an image of a paper document that has been placed in a viewing area of the camera device 310. Specifically, a user may place a part of the document that contains the graphic 106 with the encoded tag data 152 within the field of view of the camera device 310. The camera device 310 may then capture an image of the graphic 106. The captured image may be forwarded to the image processing application 320 for processing. The processing may include formatting the image data for transport across a network 150 to server 110 via the communications interface 215. The formatted image may then be transported across the network 150 to the server 110.

The tablet computer 170 and smartphone/PDA 175 may be coupled to the network or a computer over a wireless connection. Typical wireless connections may include the Bluetooth protocol, any of the 802.11 family of protocols used ubiquitously for local area network (LAN) connections, or one or more RF cellular protocols capable of interfacing a mobile communications network with a network 150 such as the Internet.

In embodiments that include a tag decoder application 325, the captured image data may be subject to the same processing as described above with respect to the data tag decoder 120 of FIG. 1. Thus, the tag decoder application 325 decodes the image to recover the document metadata for the scanned graphic 106. The image processing application 320 may then create a web service call to the server 110 in which the web service call includes the document metadata. The web service call may then be forwarded to the server 110 over network 150 by means described above.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

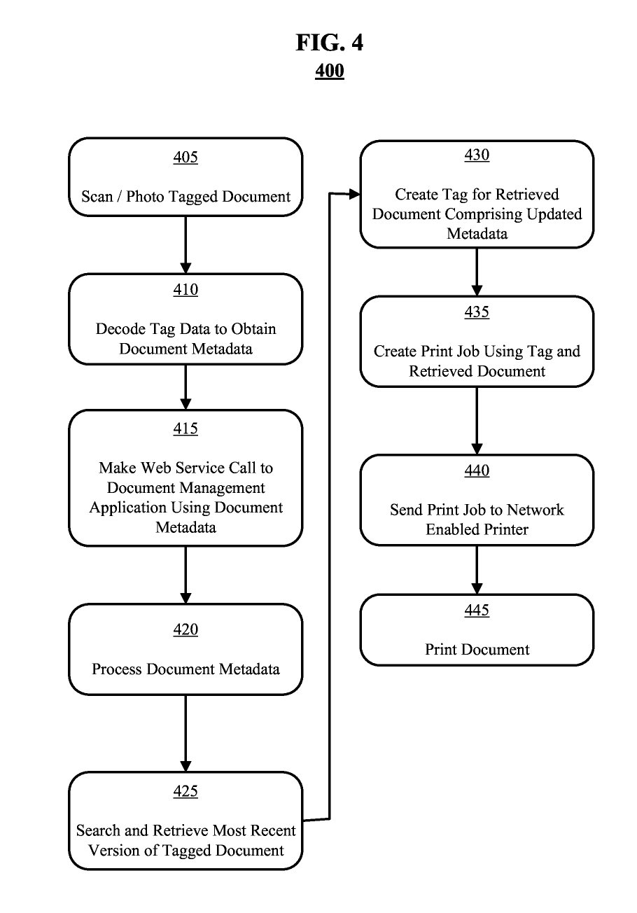

FIG. 4 illustrates an embodiment of a logic flow. The logic flow 400 may be representative of some or all of the operations executed by one or more embodiments described herein. The embodiments are not necessarily limited to the examples described herein.

In the illustrated embodiment shown in FIG. 4, the logic flow 400 may permit the server 110 to receive and process document metadata to search for and obtain a document, create a tag for the document with up to date metadata and create a print job 133 that includes the tag and the document. The print job 133 may then be sent such that a network enabled printer 160 connected through the network 150 may be caused to print the print job 133. The logic flow 400 may be representative of some or all of the operations executed by one or more embodiments described herein.

In the illustrated embodiment shown in FIG. 4, the logic flow 400 may scan or photograph the tagged document 105 at block 405. For example, a scanner 165 or tablet computer 170 or smartphone/PDA 175 (or other suitable imaging device) may capture an image of the graphic 106 within a tagged document 105 that contains the encoded document metadata. A scanner 165 may scan the graphic portion 106 of the tagged document 105 while a camera equipped tablet computer 170 or camera equipped smartphone/PDA 175 may take a photo of the graphic portion of the tagged document 105. The scanner 165, tablet computer 170, or smartphone/PDA 175 may or may not be equipped with a tag decoder application.

In the illustrated embodiment shown in FIG. 4, the logic flow 400 may decode the tag data embedded within the graphic at block 410. For example, if the imaging device (e.g., scanner 165, tablet computer 170, or smartphone/PDA 175) is equipped with a tag decoder application 225, 325, the graphic 106 may be decoded by the imaging device to recover the document metadata of the tagged document 105.

In the illustrated embodiment shown in FIG. 4, the logic flow 400 may make a web service call 154 to server 110 at block 415. For example, the imaging device may be communicatively coupled with the network 150 (or may be communicatively coupled with an intermediate device such as a computer that is communicatively coupled with the network 150). The imaging device may create a web service call 154 that contains the decoded document metadata. The web service call 154 may then be uploaded to a document management application 115 operative on server 110 via a network interface 111.

In the illustrated embodiment shown in FIG. 4, the logic flow 400 may process the document metadata to determine the most recent version of the tagged document 105 at block 420. For example, the document management application 115 may parse the document metadata to determine document characteristics such as document name, document location, and document version number.

Using this information the document management application 115 may search for and retrieve the document from document repository 125 at block 425. For example, upon locating the document in the document repository, the document management application 115 may determine if the version of the found document is newer than the version contained in the metadata. The document management application 115 may then retrieve the most recent version of the document.

In the illustrated embodiment shown in FIG. 4, the logic flow 400 may create a tag for the retrieved document comprising updated metadata at block 430. For example, the document tagging module 130 may utilize, for example, a technique known as clustered dot half-toning as is commonly used in both dry toner and liquid toner electro-photographic processes. More specifically, the tagging method may take as input any grayscale image (e.g., logo) and a payload of data (e.g., document metadata) to be encoded and produce a bi-tonal clustered dot halftone of that image in which selected halftone clusters are shifted to carry varying numbers of bits from the payload data (e.g., a graphical tag). The metadata tag may be requested by and then returned to the print job module 135.

In the illustrated embodiment shown in FIG. 4, the logic flow 400 may create a print job 133 for the retrieved document at block 435. For example, the print job module 135 may receive the retrieved document and updated document metadata from the document management application 115. The print job module 135 may then forward the updated metadata to the document tagging module 130. The document tagging module 130 may then create the graphical tag containing the updated metadata. The graphical tag may then be returned to the print job module 135. The print job module 135 may then create a print job 133 by merging the graphical tag with the retrieved document. The print job 133 may be intended for a remote network enabled printer 160. The logic flow 400 may send the print job 133 to a network enabled printer 160 at block 440. For example, the print job module 135 may forward the print job 133 to the network interface 111 for subsequent transfer to a network enabled printer 160 over network 150.

In the illustrated embodiment shown in FIG. 4, the logic flow 400 may print the print job 133 at block 445. For example, the network enabled printer 160 may receive and queue the print job 133. The print job 133 may then be printed according to its place in the printer queue. The printed document is indicative of the most recent version of the original tagged document 105. In addition, the printed document will print with an updated graphic 106 containing document metadata for the most recent version of the document. This will allow the user to perform the same process at a later date if subsequent newer versions of the document are created.

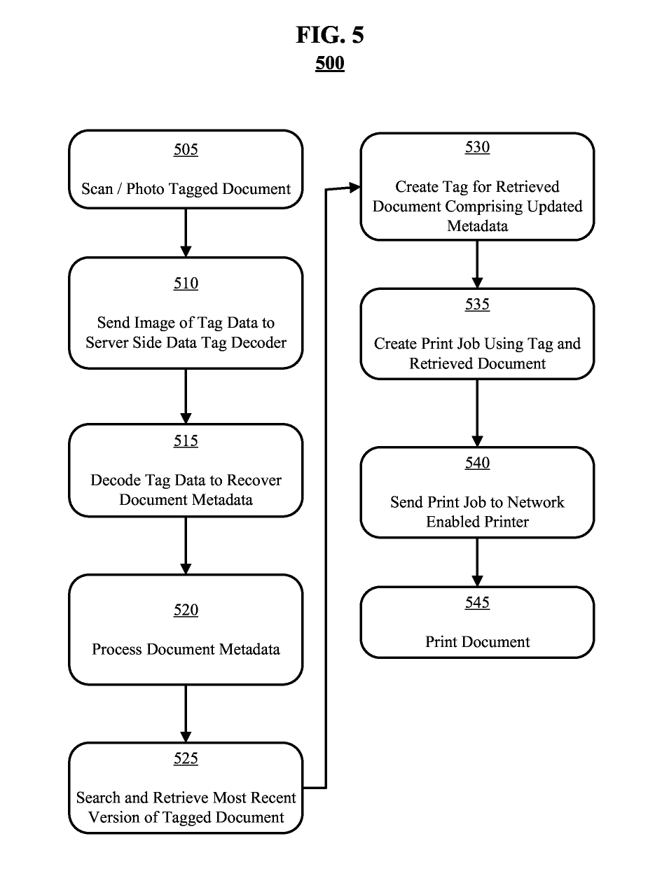

FIG. 5 illustrates an embodiment of a logic flow. The logic flow 500 may be representative of some or all of the operations executed by one or more embodiments described herein. The embodiments are not necessarily limited to the examples described herein.

In the illustrated embodiment shown in FIG. 5, the logic flow 500 may permit the server 110 to receive tag data indicative of document metadata, decode the tag, and process the document metadata to search for and obtain a document. The logic flow 500 may also create a tag for the document with up to date metadata and create a print job 133 that includes the tag and the document. The print job 133 may then be sent such that a network enabled printer 160 connected through the network 150 may be caused to print the print job 133. The logic flow 400 may be representative of some or all of the operations executed by one or more embodiments described herein.

In the illustrated embodiment shown in FIG. 5, the logic flow 500 may scan or photograph the tagged document 105 at block 505. For example, a scanner 165 or tablet computer 170 or smartphone/PDA 175 (or other suitable imaging device) may capture an image of the graphic within a tagged document 105 that contains the encoded document metadata. A scanner 165 may scan the graphic portion 106 of the tagged document 105 while a camera equipped tablet computer 170 or camera equipped smartphone/PDA 175 may take a photo of the graphic portion 106 of the tagged document 105. The scanner 165, tablet computer 170, or smartphone/PDA 175 may or may not be equipped with a tag decoder application.

In the illustrated embodiment shown in FIG. 5, the logic flow 500 may send an image of the graphic 106 containing the encoded tag data 152 to a data tag decoder 120 operative on server 110 at block 510. For example, the imaging device may be communicatively coupled with the network 150 as described above. If the imaging device (e.g., scanner 165, tablet computer 170, or smartphone/PDA 175) is not equipped with a tag decoder application, the imaging device may upload the encoded tag data 152 via communications interface 215, 315 to data tag decoder 120 operative on server 110 via network interface 111 for further processing and printing of the most recent version of the document.

In the illustrated embodiment shown in FIG. 5, the logic flow 500 may decode the tag data embedded within the graphic 106 at block 515. For example the graphic 106 may be decoded by the data tag decoder 120 operative on server 110 to recover the document metadata of the tagged document 105.

In the illustrated embodiment shown in FIG. 5, the logic flow 500 may process the document metadata to determine the most recent version of the tagged document 105 at block 520. For example, the document management application 115 may parse the document metadata recovered by the data tag decoder 120 to determine document characteristics such as document name, document location, and document version number.

Using this information the document management application 115 may search for and retrieve the document from document repository 125 at block 525. For example, upon locating the document in the document repository, the document management application 115 may determine if the version of the found document is newer than the version contained in the metadata. The document management application 115 may then retrieve the most recent version of the document.

In the illustrated embodiment shown in FIG. 5, the logic flow 500 may create a tag for the retrieved document comprising updated metadata at block 530. For example, the document tagging module 130 may utilize, for example, a technique known as clustered dot half-toning as is commonly used in both dry toner and liquid toner electro-photographic processes. More specifically, the tagging method may take as input any grayscale image (e.g., logo) and a payload of data (e.g., document metadata) to be encoded and produce a bi-tonal clustered dot halftone of that image in which selected halftone clusters are shifted to carry varying numbers of bits from the payload data (e.g., a graphical, metadata bearing tag). The metadata tag may be requested by and then returned to the print job module 135.

In the illustrated embodiment shown in FIG. 5, the logic flow 500 may create a print job 133 for the retrieved document at block 535. For example, the print job module 135 may receive the retrieved document and updated document metadata from the document management application 115. The print job module 135 may then forward the updated metadata to the document tagging module 130. The document tagging module 130 may then create the graphical tag containing the updated metadata. The graphical tag may then be returned to the print job module 135. The print job module 135 may then create a print job 133 by merging the graphical tag with the retrieved document. The print job 133 may be intended for a remote network enabled printer 160. The logic flow 400 may send the print job 133 to a network enabled printer 160 at block 440. For example, the print job module 135 may forward the print job 133 to the network interface 111 for subsequent transfer to a network enabled printer 160 over network 150.

In the illustrated embodiment shown in FIG. 5, the logic flow 500 may print the print job 133 at block 545. For example, the network enabled printer 160 may receive and queue the print job 133. The print job 133 may then be printed according to its place in the printer queue. The printed document is indicative of the most recent version of the original tagged document 105. In addition, the printed document will print with an updated graphic 106 containing document metadata for the most recent version of the document. This will allow the user to perform the same process at a later date if subsequent newer versions of the document are created.

It should be noted that the embodiments described herein may operate successfully and independently of a particular document management application 115. Many document management applications utilize representational state transfer (REST) based interfaces and application programming interfaces (APIs) that facilitate the inclusion of document metadata in a print request (e.g., document identifier, document location, and instruction to print). REST-style architectures are comprised of clients and servers. Clients may initiate requests to servers while the servers process requests and return appropriate responses. Requests and responses may be built around the transfer of representations of resources. A resource can be essentially any coherent and meaningful concept that may be addressed. A representation of a resource is typically a document that captures the current or intended state of a resource. The client may send requests when it is ready to make the transition to a new state. While one or more requests are outstanding, the client may be considered in transition. The representation of each application state may contain links that may be used the next time the client chooses to initiate a new state transition. Thus, REST facilitates the transaction between web servers by allowing loose coupling between different services.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system comprising:
a server including a processing component, the server to host and manage:
a network interface to receive and send data over a network;
a document repository to store documents;
a document management application operative to locate a document in the document repository based on received decoded document metadata and determine whether the document metadata is indicative of a most recent version of the document;
a document tagging module operative to create a tag for the retrieved most recent version of the document comprised of up to date document metadata; and
a print job module operative to merge the tag with the most recent version of the document into a print job and send the print job to a network enabled printer over the network connection to be printed.

2. The system of claim 1, the document metadata comprising a document identifier, a document version identifier and a document location identifier.

3. The system of claim 2, the server further comprising a data tag decoder component operative to:
receive tag data encoded with document metadata over the network connection, the tag data being image data obtained from imaging a graphic embedded with the tag data, the graphic present on a version of a document; and
decode the tag data to recover the document metadata.

4. The system of claim 2, the tag data further comprising data encoded in a halftone of the graphic using a clustered dot halftoning technique.

5. The system of claim 2, the document tagging module further operative to create the tag by:
receiving a grayscale image of the graphic;
receiving the document metadata to be encoded; and
producing a modified graphic comprised of a bi-tonal clustered dot halftone of the graphic having selected clusters shifted to carry varying numbers of bits from the document metadata.

6. The system of claim 2, the received tag data encoded with document metadata received over the network connection from at least one of a network enabled scanner, a network enabled computer tablet, a network enabled smartphone, and a network enabled personal digital assistant (PDA).

7. The system of claim 6, the at least one of a network enabled scanner, a network enabled computer tablet, a network enabled smartphone, and a network enabled personal digital assistant (PDA) performing the steps of:
decoding the tag data; and
creating and sending a web service call to the document management application to print the document, the web service call including the decoded document metadata.

8. A computer-implemented method, comprising:
receiving decoded document metadata;
locating a document in a document repository using the document metadata;
determining whether the document metadata is indicative of a most recent version of the document;
retrieving the most recent version of the document;
creating a tag for the retrieved most recent version of the document comprised of up to date document metadata;
creating a print job for the most recent version of the document by merging the tag with the most recent version of the document; and
sending the print job to a network enabled printer over the network connection to be printed.

9. The computer-implemented method of claim 8, the document metadata comprising a document identifier, a document version identifier and a document location identifier.

10. The computer-implemented method of claim 9, further comprising:
receiving tag data encoded with document metadata over the network connection, the tag data being image data obtained from imaging a graphic embedded with the tag data, the graphic present on a version of a document;
decoding the tag data to recover the document metadata.

11. The computer-implemented method of claim 9, the tag data further comprising data encoded in a halftone of the graphic using a clustered dot halftoning technique.

12. The computer-implemented method of claim 9, further comprising:
receiving a grayscale image of the graphic;
receiving the document metadata to be encoded; and
producing a modified graphic comprised of a bi-tonal clustered dot halftone of the graphic having selected clusters shifted to carry varying numbers of bits from the document metadata.

13. The computer-implemented method of claim 9, the received tag data encoded with document metadata received over the network connection from at least one of a network enabled scanner, a network enabled computer tablet, a network enabled smartphone, and a network enabled personal digital assistant (PDA).

14. The computer-implemented method of claim 13, the at least one of a network enabled scanner, a network enabled computer tablet, a network enabled smartphone, and a network enabled personal digital assistant (PDA) performing the steps of:
decoding the tag data; and
creating and sending a web service call to the document management application to print the document, the web service call including the decoded document metadata.

15. At least one tangible computer-readable storage medium comprising instructions that, when executed, cause a system to:
receive decoded document metadata;
locate a document in the document repository using the document metadata;
determine whether the document metadata is indicative of a most recent version of the document;
retrieve the most recent version of the document;
create a tag for the retrieved most recent version of the document comprised of up to date document metadata;
create a print job for the most recent version of the document by merging the tag with the most recent version of the document; and
send the print job to a network enabled printer over the network connection to be printed.

16. The tangible computer-readable storage medium of claim 17, the document metadata comprising a document identifier, a document version identifier and a document location identifier.

17. The tangible computer-readable storage medium of claim 16, comprising instructions that when executed cause the system to:
receive tag data encoded with document metadata over the network connection, the tag data being image data obtained from imaging a graphic embedded with the tag data, the graphic present on a version of a document;
decode the tag data to recover the document metadata.

18. The tangible computer-readable storage medium of claim 16, comprising instructions that when executed cause the system to encode tag data in a halftone of the graphic using a clustered dot halftoning technique.

19. The tangible computer-readable storage medium of claim 16, comprising instructions that when executed cause the system to:
receive a grayscale image of the graphic;
receive the document metadata to be encoded; and
produce a modified graphic comprised of a bi-tonal clustered dot halftone of the graphic having selected clusters shifted to carry varying numbers of bits from the document metadata.

20. The tangible computer-readable storage medium of claim 16, comprising instructions that when executed cause the system to:
receive a web service call from at least one of a network enabled scanner, a network enabled computer tablet, a network enabled smartphone, and a network enabled personal digital assistant (PDA), the web service call including the decoded document metadata.
